(19) United States
(12) Patent Application Publication
(10) Pub. No.: US 2012/0258267 A1
(43) Pub. Date: Oct. 11, 2012

(54) Dripping Off Mat

(76) Inventors: Timm Kroll, Unna (DE); Peter Kroll, Houston, TX (US)

(21) Appl. No.: 13/381,222

(22) PCT Filed: Jul. 1, 2010
(86) PCT No.: PCT/EP10/03917

§ 371 Date: Jun. 25, 2012

(30) Foreign Application Priority Data
Jul. 2, 2009 (DE) 20 2009 009 082.5

(51) Int. Cl. B32B 1/06; B32B 1/02

(52) U.S. Cl. 428/35.7; 428/34.1

(57) ABSTRACT

The invention relates to a drip mat for equipment such as drill rods, drill pipes, and accessories therefor. The drip mat comprises several components, such as a flat base plate, one or more bounding webs surrounding the base plate at the edges thereof, which bounding webs together with the base plate form a container that is open at the top, wherein the bounding webs are provided in some areas with slot-shaped recesses that are open at the top.

The invention relates to a drip mat, referred to in English-speaking world as “mud mat” for equipment such as drill pipe, drill pipe and accessories thereto. Such drill pipe, drill pipe and accessories for oil or gas drilling rigs used on land and at sea in order to store the equipment shortly after use, thus adhering mud, ie oil, natural gas or rock groups or additional funds from the drilling operations, etc. drain and can occur.

In the prior art lattice drip mats are known. The mats must be made very stable, so that they use in harsh conditions on oil rigs or drilling on land stood a while to keep. In general, the grid-shaped drip mats are made from wood. The disadvantage here is one for the requirement that the grid-like mats, the amount of incurred drilling mud, and thus often can not accommodate the storage place is dirty, that they are difficult to clean due to its durability and that this often-used tropical timber in ecological terms is not harmless.

For the innovation was therefore the object of avoiding these disadvantages and easy to clean, durable, easy to produce drip mats provide, which has a high absorption capacity for drilling mud.

This problem is solved by the features of the main claim. Further advantageous embodiments are disclosed in the subclaims.

In this case, according to the innovation drip mat for drill pipe and tube on several components, namely first a flat base plate, continue one or more of the base plate at its edges surrounding boundary webs which form the base plate with an open top container, with the

Limiting ridges in regions with slit-shaped upwardly open recesses are provided, so that they get a comb-like appearance.

Furthermore, the drip mat on several over the surface of the base plate distributed holding webs, which are provided with a slit-shaped upwardly open recesses so that the retaining bars look like a comb.

Finally, the drip mat contains several footbridges, in which the slitlike are inserted upwardly open recesses of the limitation of bridges and retaining bars so that between the bridge piers and the receive a base plate spacing remains.

This gives you a number of rectified through the support webs—and of course at the edges by the boundary bridges—channels formed above the base plate from which the drilling fluid can flow easily directed and can be rinsed out very easily with a hot steamer. The channels are covered by the limitation of bridges, footbridges and retaining bars also formed above the grid channels, so that renewal in accordance with the equipment can drain through the mesh and the drilling mud through the channels can be removed or expires.

The depth of the slot-shaped recesses open at the top of the boundary webs and the support webs are generally sufficient to half the height of the boundary webs or retaining bars, but can also adapt each of the slotted into the engaging recesses open at the top bridge supports are to be designed differently. It is advantageous that the distance between the bridge piers and the base plate is sufficient to provide a safe draining of the amount of drilling mud and a light rinse to ensure an advantageous further development is that the base plate is rectangular, with her head drip mat sides a web has limitation, with the slit-shaped upwardly open and the recesses is provided on its longitudinal sides a limitation web which is formed without recesses. This allows for simplified manufacturing and again an arbitrary number of unidirectional channels and is responsible for transportation to the application and adapt easily to the drill site.

Another advantageous embodiment consists in that the retaining bars parallel to the sides of the head, ie parallel to the ribs and the head-side boundary-bridges in parallel to the sides, ie, the longitudinal limiting bars are located.

This also simplifies the manufacturing and construction and also creates a grid-like and stable structure.

Another advantageous embodiment consists in that the retaining bars are positioned and footbridges in only one portion of the base plate. So that no one part of the area drip mat remain free of the base plate components arranged so that a kind of “melting pot” is created in which the leaking equipment collected from the mud and from which it can be flushed out later.

Another advantageous embodiment is that the base plate, limitation bars, footbridges and retaining bars are made of plastic. This protects the wood previously used resources and leads to strength and durability of drip mat can be adjusted within wide limits.

Another advantageous embodiment is that in an embodiment of the plastic base plate, limiting Bridges, footbridges and retaining bars are welded together at least partially. This simplifies the production and increases the strength of the mat.

Another advantageous embodiment is that limitation bars, grab bars and footbridges are at least partially screwed together. Also, this will increase your strength.

A further advantageous development is that several or all support webs in their orientation, with the slit-shaped upwardly open recesses provided with a range over the longer-end of the retaining bars long screw inserted with the footbridges are screwed. This is the life and durability of the drip mat increases while maintaining their flexibility.

Reference to an embodiment, the invention will be explained in more detail. Shown 1 shows an overall view of the proper renewal drip mat from above, with base plate, limitation and bars holding webs footbridges, 3 shows a detailed view of a corner of renewal-date drip mat.

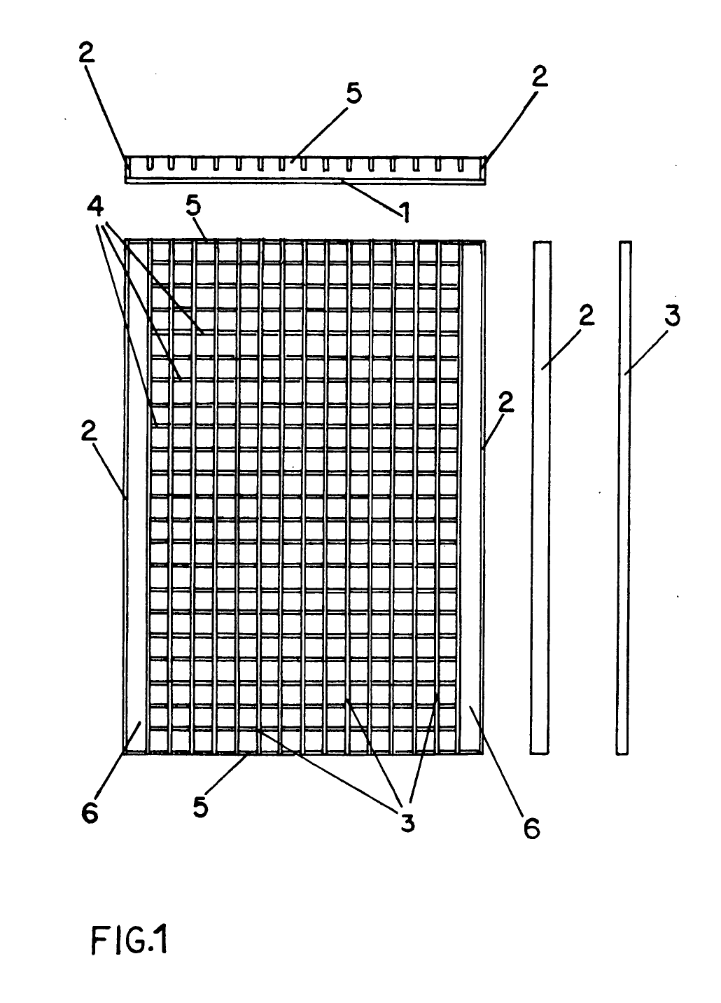

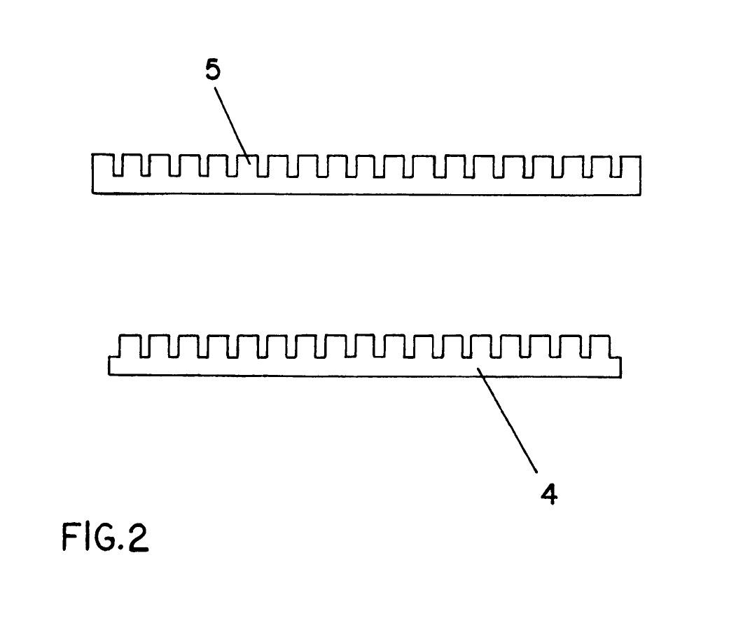

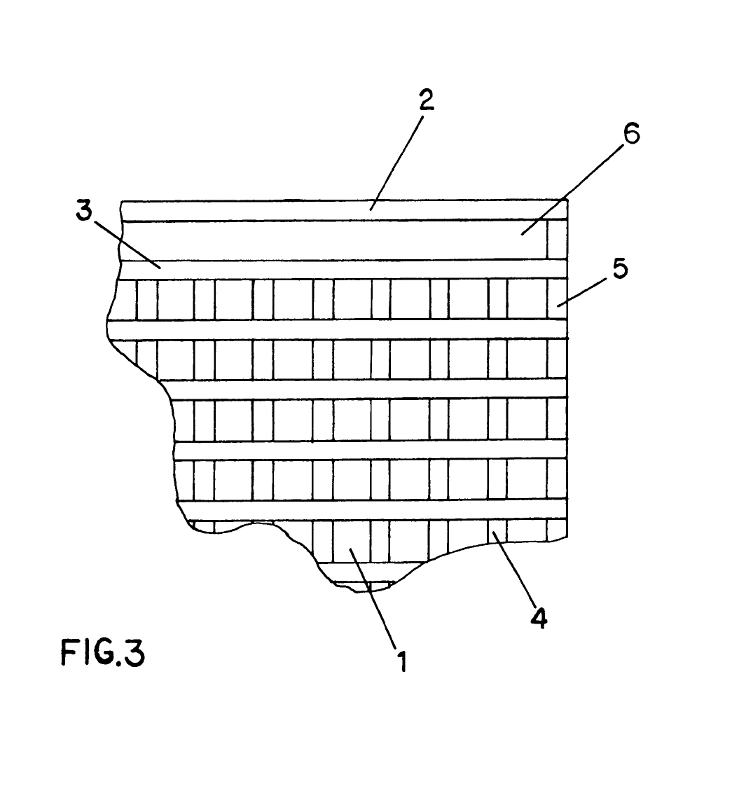

1 shows an overall view of the proper renewal rectangular drip mat from above, with a base plate, the head-side boundary webs 5 and the longitudinal ridges second limitation Also shown are the retaining bars 4 and the 3-bridges, which are attracted here for simplicity, only some of the support webs and webs of the bridge with the reference numerals 3 and 4. The head-side boundary webs 5 and the retaining bars 4 are provided with upwardly open recesses schlitzfömigen. The right part of FIG. 1 is shown a drawing properly folded to the right view of the bars 2 and 5 and the base plate 1 of drip mat. In the lower part of the drawing of FIG. 1 are shown a drawing properly folded down view of the webs 2 and 3 of the support webs drip mat.

2 shows a head-side boundary and a retaining bar 5 bar 4 of the contemporary renewal drip mat as individual parts in the side view. Here we see that the support webs are shorter than the head-side support webs 4 5 formed, leaving a free on the sides of drip mat part surfaces 6 of drip mat, so that a kind of “melting pot” is created in which the leaking from the equipment drilling mud accumulates and from which it can be flushed out later. 2 shows a detailed view of a corner of the drip mat renewal according to the plan view. Also here you can see the head-side boundary ridge 5, along the side boundary webs 2, the retaining bars 4, the three footbridges and the remaining free space part 6 of renewal according drip mat how they meet each other in the corner of the mat. The head-side boundary along side the bridge 5 and limiting ribs 2 are provided on their upper, outer surface with a chamfer of 45°. All items are made of plastic and are welded together.

### LIST OF REFERENCE NUMERALS

1 base plate
2 along side boundary bridge
3 bridge bridge
4 retaining web
5-page limit jetty head
Six remaining free space part

1. A drip mat for drill pipes and tubes, comprising:
a base plate,
boundary ridges at the base plate edges, said boundary ridges together with the base plate forming an open top container,
a web comprised of a plurality of support bars spaced from one another and extending in a first direction, said support bars having upwardly facing recesses for receiving bridge bars, and a plurality of bridge bars extending in a second, transverse direction positioned in the recesses of the support bars.

2. The drip mat according to claim 1, wherein the base plate is rectangular, and wherein the drip mat has at its head sides a head-side boundary web, with slit-shaped upwardly open recesses and at its longitudinal sides a longitudinal boundary web without recesses.

3. The drip mat according to claim 2, wherein the retaining bars are parallel to the sides of the head, and the bridge webs are arranged parallel to the longitudinal sides.

4. The drip mat according to claim 1, with the support webs and footbridges arranged only in a portion of the base plate.

5. The drip mat according to claim 1, wherein the base plate, limiting bridges, retaining bars and footbridges are plastic.

6. The drip mat according to claim 4, wherein the base plate, limiting Bridges, retaining bars and footbridges are at least partially welded together.

7. The drip mat according to claim 1, wherein the limit bars, retaining bars and footbridges are at least partially screwed together.

8. The drip mat according to claim 2, wherein the holding bars are in their orientation, with slit-shaped upwardly open recesses along the length of the holding bars.

9. (canceled)
